(19) United States
(12) Patent Application Publication
(10) Pub. No.: US 2014/0062903 A1
(43) Pub. Date: Mar. 6, 2014

(54) SCREEN UNLOCKING METHOD WITH TIME INFORMATION SCREEN UNLOCKING SYSTEM WITH TIME INFORMATION, AND RECORDING MEDIUM

(71) Applicant: INSTITUTE FOR INFORMATION INDUSTRY, Taipei City (TW)

(72) Inventors: Chih-Kung LEE, Taipei City (TW); Chia-Hsiang CHANG, Taipei City (TW); Yung-Chieh HUNG, Taipei City (TW); Emery JOU, Taipei City (TW); Kun-Hung LEE, Taipei City (TW); Jing-Fung CHEN, New Taipei City (TW); Pei-Wen HUANG, Taipei City (TW); Yueh-Ying CHANG, Taipei City (TW)

(73) Assignee: INSTITUTE FOR INFORMATION INDUSTRY, Taipei City (TW)

(21) Appl. No.: 13/670,084

(22) Filed: Nov. 6, 2012

(30) Foreign Application Priority Data
Aug. 31, 2012 (TW) 101131766

(51) Int. Cl. G06F 3/02

(52) U.S. Cl. CPC G06F 3/02
USPC 345/173

(57) ABSTRACT

A screen unlocking method with time information, a screen unlocking system with time information, and a recording medium are provided, and the method is applicable to an electronic device. The unlocking method includes the following steps: first, obtaining unlocking information through a detection module, where the unlocking information includes an unlocking instruction set and an unlocking time series; judging, by using an operation processing module, whether the unlocking instruction set and the unlocking time series in the unlocking information conform to a preset unlocking instruction set and a preset unlocking time series in preset unlocking information respectively; and if the unlocking instruction set and the unlocking time series conform to the preset unlocking instruction set and the preset unlocking time series respectively, enabling a touch display module to be unlocked and to correspondingly enter an operation picture with an application function.

### CROSS-REFERENCE TO RELATED APPLICATION

This application claims the benefit of Taiwan Patent Application No. 101131766, filed on Aug. 31, 2012, which is hereby incorporated by reference for all purposes as if fully set forth herein.

### BACKGROUND

1. Field of Invention

The present invention relates to a screen unlocking method, a screen unlocking system, and a recording medium, and more particularly to a screen unlocking method with time information, a screen unlocking system with time information, and a recording medium, where an unlocking action corresponds to unlocking time.

2. Related Art

With the high development of technologies, various electronic and electrical products enter people's daily life and work. On one hand, the technology development brings much convenience to people; on the other hand, multiple non-intuitive operating manners emerge at the same time. For example, after an ordinary electronic device such as a cell phone or a Personal Digital Assistant (PDA) are left unused for a period of time, a touch screen enters a dormant state and/or a locking state, so as to prevent a user from touching by mistake and avoid unnecessary energy consumption. Afterwards, when the user desires to use the electronic device to execute a certain function, and the screen of the electronic device is in a locking state, the screen needs to be first unlocked, and then the electronic device can be operated.

At present, multiple manners of unlocking the touch screen exist. For example, the touch screen can be unlocked and awaken/started through transverse sliding, vertical sliding, a specific sliding path, or an unlocking pattern on the touch screen, or by inputting a specific password. For part of holders not owning the cell phone and the PDA, the foregoing unlocking manner is simple, easily resulting in a crisis of privacy leakage of the holders owning the cell phone and the PDA. Therefore, an objective of the present invention is to provide an unlocking method which is convenient and capable of improving privacy for the holders owning the cell phone and the PDA, and prevents the cell phone and the PDA from being unlocked and used by another person at will.

### SUMMARY

The present invention provides a screen unlocking method with time information, a screen unlocking system with time information, and a recording medium, so as to improve unlocking convenience and privacy of the cell phone and the PDA.

The present invention provides a screen unlocking method with time information, a screen unlocking system with time information, and a recording medium, for an electronic apparatus to execute the foregoing screen unlocking method, where the steps of the method are described in the abstract, and the details are not described herein again.

### BRIEF DESCRIPTION OF THE DRAWINGS

The present invention will become more fully understood from the detailed description given herein below for illustration only, and thus are not limitative of the present invention, and wherein:

FIG. 1 is a block diagram of elements of a screen unlocking system with time information according to the present invention;

FIG. 2A is a flowchart of steps of a screen unlocking method with time information according to the present invention.

FIG. 2B is a flowchart of steps of presetting preset unlocking information according to the present invention;

FIG. 2C is a flowchart of steps of awaking an electronic device according to the present invention;

FIG. 2D is a flowchart of steps of judging whether unlocking time is overtime according to the present invention;

FIG. 3 is a flowchart of steps of using movement/rotation of a cell phone as unlocking information according to the present invention;

FIG. 4 is a perspective diagram of a first embodiment of a touch screen unlocking prompt for screen unlocking according to the present invention;

FIG. 5 is a perspective diagram of a second embodiment of a touch screen unlocking prompt for screen unlocking according to the present invention;

FIG. 6 is a perspective diagram of a third embodiment of a touch screen unlocking prompt for screen unlocking according to the present invention;

FIG. 7A is a perspective diagram of a fourth embodiment of a touch screen unlocking prompt for screen unlocking according to the present invention; and

FIG. 7B is a perspective diagram of a fifth embodiment of a touch screen unlocking prompt for screen unlocking according to the present invention.

### DETAILED DESCRIPTION

In order to make the features and advantages of the present invention more comprehensible, the present invention is described in further detail below with reference to embodiments and the accompanying drawings.

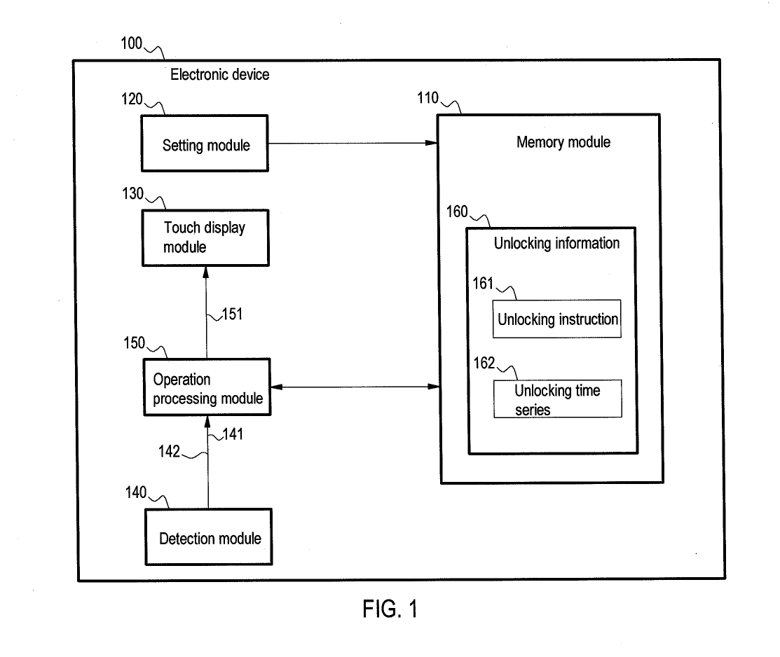

FIG. 1 is a block diagram of elements of a screen unlocking system with time information according to the present invention. In FIG. 1, the screen unlocking system with time information is applicable to an electronic device 100 which includes a memory module 110, a setting module 120, a touch display module 130, a detection module 140, and an operation processing module 150.

The setting module 120 is used to set preset unlocking information 160, where the preset unlocking information 160 includes a preset unlocking instruction set 161 and a preset unlocking time series 162; and store the preset unlocking information 160 in the memory module 110. The detection module 140 obtains unlocking information (not shown) including an unlocking instruction set 141 and an unlocking time series 142. The operation processing module 150 is electrically connected to the memory module 110, the detection module 140, and the touch display module 130. When the operation processing module 150 obtains through comparison that the unlocking instruction set 141 and the unlocking time series 142 included in the unlocking information conform to the preset unlocking instruction set 161 and the preset unlocking time series 162 included in the preset unlocking information 160, the operation processing module 150 outputs an unlocking signal 151 to the touch display module 130; and then the touch display module 130 is unlocked according to the unlocking signal 151 and correspondingly enters an operation picture with an application function.

The electronic device 100 is further disposed with a trigger key 101, so as to awake the electronic device 100 through the trigger key 101, and the touch display module 130 displays an unlocking prompt message.

In this embodiment, the touch display module is further disposed with several input blocks, and several operating signals are obtained through the input blocks, so as to generate an unlocking instruction set.

In this embodiment, the unlocking instruction set includes a unlocking instruction, each of the unlocking instructions corresponds to unlocking time, and several pieces of unlocking time are combined into an unlocking time series.

In this embodiment, the electronic device is further disposed with an electronic compass to sense a moving direction and a rotation manner of the electronic device, and use the sensed moving direction and the sensed rotation manner as an unlocking instruction.

In this embodiment, the electronic device is further disposed with a gyroscope to sense a moving direction and a rotation manner of the electronic device, and use the sensed moving direction and the sensed rotation manner as an unlocking instruction.

In this embodiment, the electronic device is further disposed with an audio capture unit to obtain an unlocking voice signal and use the sensed unlocking voice signal as an unlocking instruction.

In this embodiment, the electronic device is further disposed with an image capture unit to obtain an unlocking image signal and use the sensed unlocking image signal as an unlocking instruction.

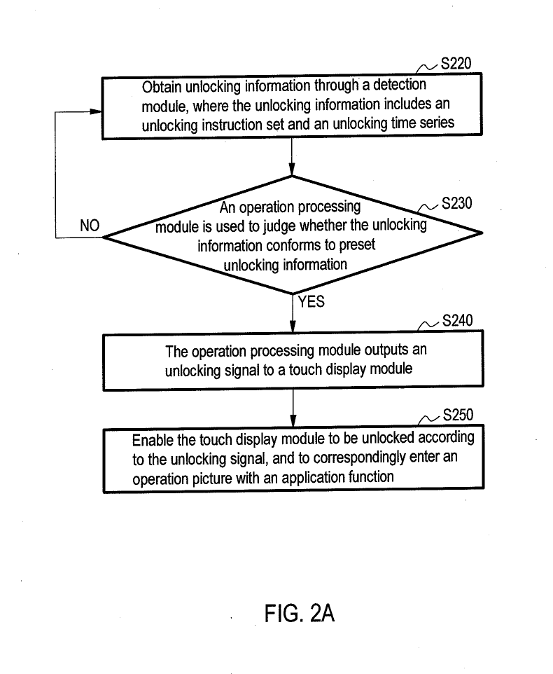

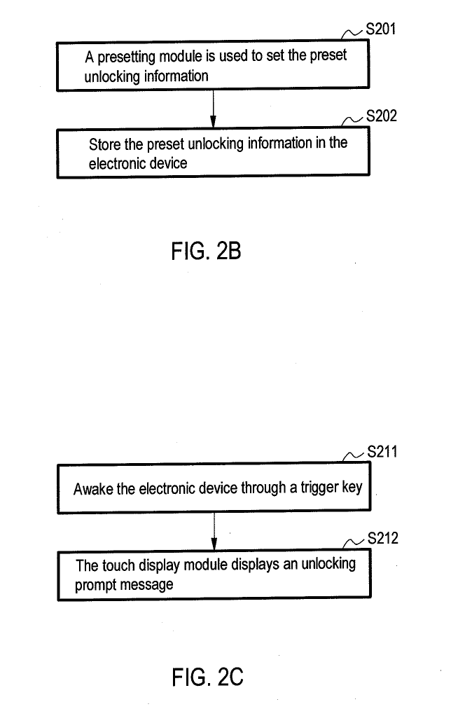

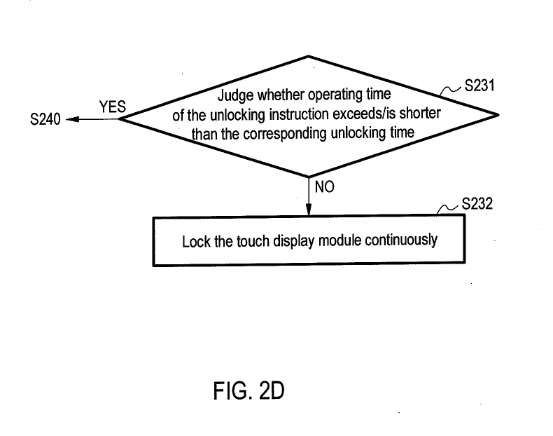

FIG. 2A is a flowchart of steps of a screen unlocking method with time information according to the present invention. Reference is made to FIG. 1 for the relevant elements involved in the steps. The main steps of FIG. 2A are as follows.

Step S220: Obtain unlocking information through a detection module, where the unlocking information includes an unlocking instruction set and an unlocking time series; the unlocking instruction set refers to a set formed by a unlocking instruction; and the unlocking time series is formed by arranging, according to a sequence of the unlocking instructions, unlocking time in cooperation with the unlocking time corresponding to the unlocking instructions.

Step S230: An operation processing module is used to judge whether the unlocking information conforms to preset unlocking information, where the preset unlocking information is set in the electronic device through a setting module, and includes a preset unlocking instruction set and a preset unlocking time series, of which the main content is as described in FIG. 2B.

Step S240: The operation processing module outputs an unlocking signal to a touch display module, where the operation processing module compares the preset unlocking information with the unlocking information input by the user, compares the corresponding preset unlocking instruction set with the unlocking instruction set according to the preset unlocking time series in the preset unlocking information and the unlocking time series in the unlocking information, and outputs an unlocking signal to unlock the touch display module when the preset unlocking time series and the preset unlocking instruction set included in the preset unlocking information conform to the unlocking time series and the unlocking instruction set in the unlocking information input by the user, that is, the unlocking information input by the user is the correct unlocking information.

Step S250: Enable the touch display module to be unlocked according to the unlocking signal, and to correspondingly enter an operation picture with an application function. Generally speaking, screen locking may be switched by the user personally, or the electronic device itself converts the screen state into a locking state as the idle time interval exceeds a preset time interval. Therefore, after the touch display module is unlocked, the touch display module of the electronic device may display a picture which may be a homepage, before the locking, or an application picture in the operation.

FIG. 2B is a flowchart of steps of presetting the preset unlocking information according to the present invention. Referring to FIG. 2B, the main steps are as follows.

Step S201: A presetting module is used to set the preset unlocking information, where the preset unlocking information includes a preset unlocking instruction set and a preset unlocking time series; the preset unlocking instruction set refers to a set formed by a preset unlocking instruction; the preset unlocking time series is formed by arranging, according to a sequence of the preset unlocking instructions, preset unlocking time in cooperation with each preset unlocking instruction and the preset unlocking time corresponding to the preset unlocking instructions.

Step S202: Store the preset unlocking information in the electronic device, based on which comparison is performed when the user unlocks the screen each time.

FIG. 2C is a flowchart of steps of awaking an electronic device according to the present invention. Reference is made to FIG. 1 for the relevant elements involved in the steps. The main steps of FIG. 2C are as follows.

Step S211: Awake the electronic device according to a trigger signal. Since the electronic device also turns off a backlight module of the touch display module at the same time of locking the touch display module, so as to enter a power-saving mode, when the user is about to start the touch display module, the user needs to start the touch display module and the backlight module of the touch display module through a trigger key.

Step S212: The touch display module displays an unlocking prompt message; following step S211, after the touch display module and the backlight module of a touch screen are started through the trigger key, the touch display module can enter the operation picture with an application function only after prompting the user to input unlocking information.

FIG. 2D is a flowchart of steps of judging whether the unlocking time is overtime according to the present invention. The steps are performed after step S230 in FIG. 2A, and include the following content.

Step S231: Judge whether operating time of the unlocking instruction exceeds/is shorter than the corresponding unlocking time. Since in the unlocking manner provided by this method, duration is also a key factor of the unlocking, in this step, attention should also be paid to the duration of the whole unlocking process in addition to the duration corresponding to each unlocking instruction, so as to avoid that an unlocking test is performed on the electronic device for a long period of time, that is, too long or too short unlocking time does not conform to the control of the unlocking time.

Step S232: Lock the touch display module continuously; following step S231, after the unlocking time exceeds preset time, continuously lock the screen.

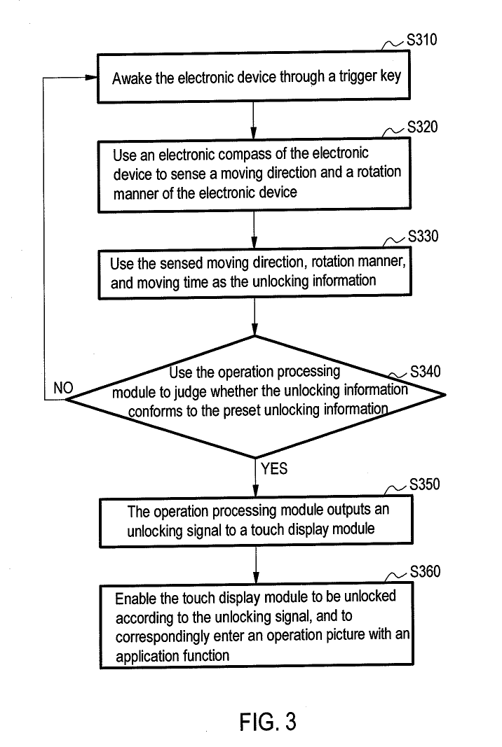

FIG. 3 is a flowchart of steps of using movement/rotation of a cell phone as unlocking information according to the present invention. The steps are as follows.

Step S310: Move and meanwhile rotate an electronic device in a specific manner, where the electronic device can be moved vertically up and down, or horizontally front and back or left and right, and the moving manner should be fixed.

Step S320: Use an electronic compass of the electronic device to sense a moving direction and a rotation manner of the electronic device, and obtain, through analysis, the vertical up and down or horizontal front and back or left and right moving manner, or rotation manner of the electronic device through the electronic compass, where the electronic compass may be a gyroscope.

Step S330: Use the sensed moving direction, rotation manner, and moving time as the unlocking information, and through step S331 and step S332, use the moving manner and/or the rotation manner of the electronic device as the unlocking information.

Step S340: Use the operation processing module to judge whether the unlocking information conforms to the preset unlocking information; if yes, perform step S350; if no, return to step S310, where the operation processing module compares the preset unlocking information with the unlocking information input by the user, and compares the preset unlocking instruction set with the unlocking instruction set corresponding thereto one by one.

Step S350: The operation processing module outputs an unlocking signal to a touch display module; following step S340, when the preset unlocking time series and the preset unlocking instruction set included in the preset unlocking information indirectly conform to the unlocking time series and the unlocking instruction set in the unlocking information input by the user, the operation processing module outputs an unlocking signal to unlock the touch display module.

Step S360: Enable the touch display module to be unlocked according to the unlocking signal, and to correspondingly enter an operation picture with an application function, where the screen locking may be switched by the user personally into a locking state or converted by the electronic device itself into a locking state as the idle time exceeds the set time; therefore, when the touch display module is unlocked, the touch display module of the electronic device restores a picture before the locking.

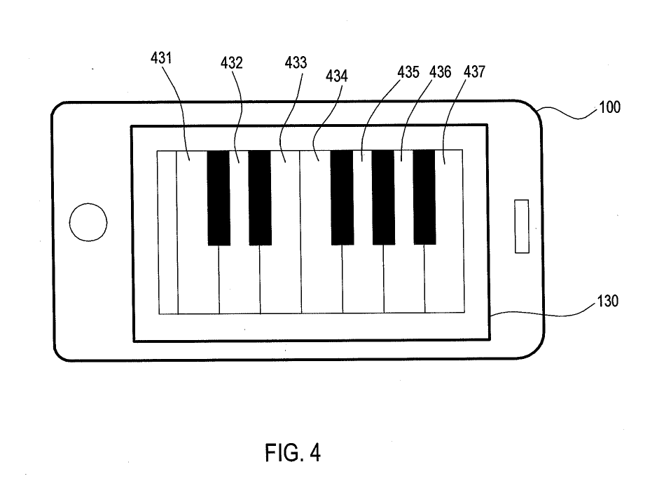

FIG. 4 is a perspective diagram of a first embodiment of a touch screen unlocking prompt for screen unlocking according to the present invention. In FIG. 4, the touch display module 130 of the electronic device 100 displays a group of musical instrument keys, which respectively represent seven scale keys: Do key 431, Re key 432, Mi key 433, Fa key 434, So key 435, La key 436, and Si key 437. During setting of the unlocking information, a short music scale may be used as the unlocking information. Taking “Little Star” as an example, the first four sections [Do, Do, So, So; La, La, So˜; Fa, Fa, Mi, Mi; Re, Re, Do˜] of the music scale may be selected, that is, the keys [Do key 431, Do key 431, So key 435, So key 435, La key 436, La key 436, So key 435˜; Fa key 434, Fa key 434, Mi key 433, Mi key 433; Re key 432, Re key 432, Do key 431] should be sequentially pressed, which are used as the unlocking instruction set. Each musical note is used as one instruction, and each beat needs to be completed within preset time. If the rhythm time exceeds or is shorter than a time interval, it is determined that the unlocking information does not conform to the preset unlocking information. In other words, if a note key is pressed by mistake, and meanwhile it is also determined that the unlocking information does not conform to the preset unlocking information, the screen is continuously locked.

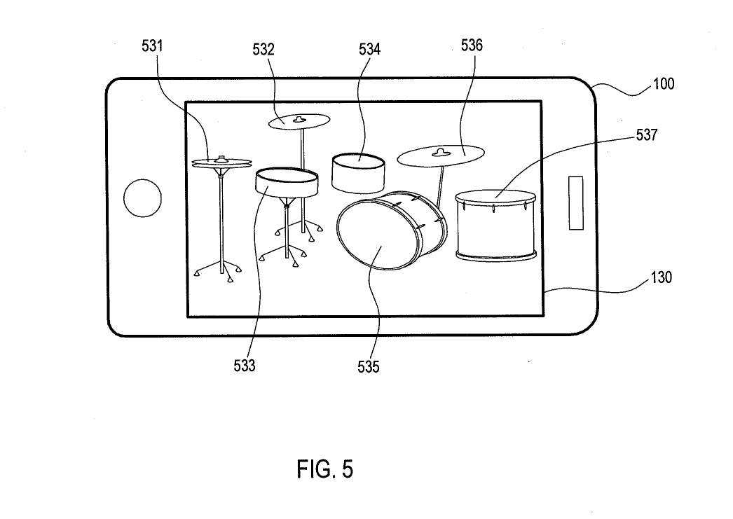

FIG. 5 is a perspective diagram of a second embodiment of a touch screen unlocking prompt for screen unlocking according to the present invention. In FIG. 5, the touch display module 130 of the electronic device 100 displays a group of musical instruments, which are respectively a musical instrument A531, a musical instrument B532, a musical instrument C533, a musical instrument D534, a musical instrument E535, a musical instrument F536, and a musical instrument G537. The user may adopt the following manner for unlocking according to personal preference.

(1) Click one same musical instrument several times within unlocking time. For example, the musical instrument A531 is sequentially clicked three times [musical instrument A531, musical instrument A531, musical instrument A531], and the musical instrument F536 is clicked four times [musical instrument F536, musical instrument F536, musical instrument F536, musical instrument F536] within next unlocking time.

(2) Click several musical instruments within unlocking time. For example, [musical instrument B532, musical instrument C533, musical instrument F536, musical instrument G537] are sequentially clicked within first unlocking time, and [musical instrument C533, musical instrument E535, musical instrument D534, musical instrument A531] are sequentially clicked within second unlocking time.

(3) Click one same musical instrument several times within first unlocking time, and click several musical instruments within second unlocking time. For example, the musical instrument G537 is sequentially clicked three times [musical instrument G537, musical instrument G537, musical instrument G537], and [musical instrument C533, musical instrument E535, musical instrument D534] are sequentially clicked within second unlocking time; the tones are staggered in this way to form a short movement, and the short movement is used as unlocking information.

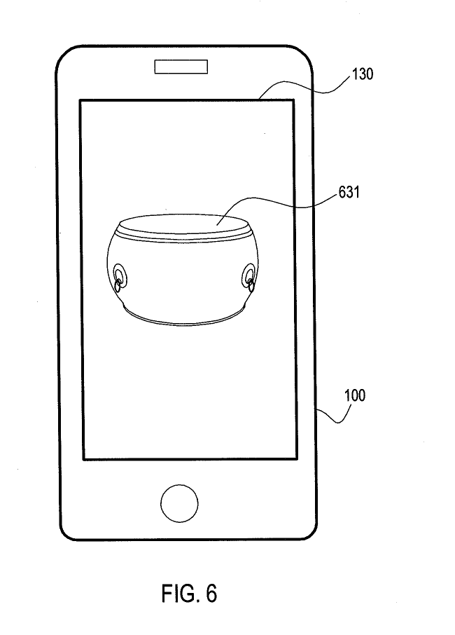

FIG. 6 is a perspective diagram of a third embodiment of a touch screen unlocking prompt for screen unlocking according to the present invention. The touch display module 130 of the electronic device 100 displays a drum 631. In the unlocking time series of the unlocking information, the drum 631 is beaten with different rhythms in different unlocking time, and the different unlocking time is collocated with different drum beating rhythms to form unlocking information.

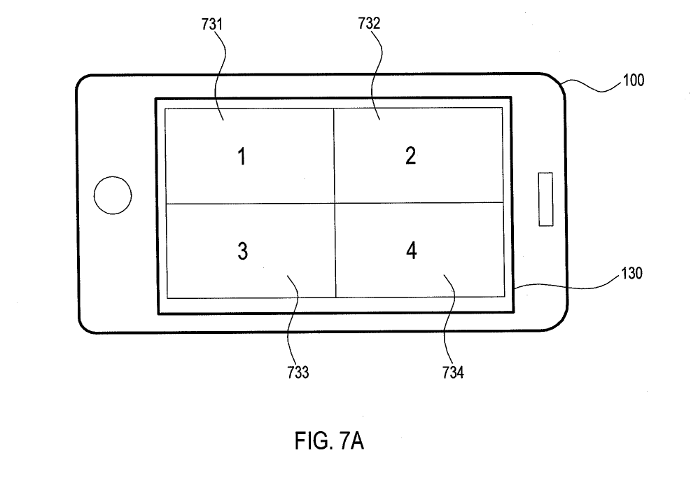

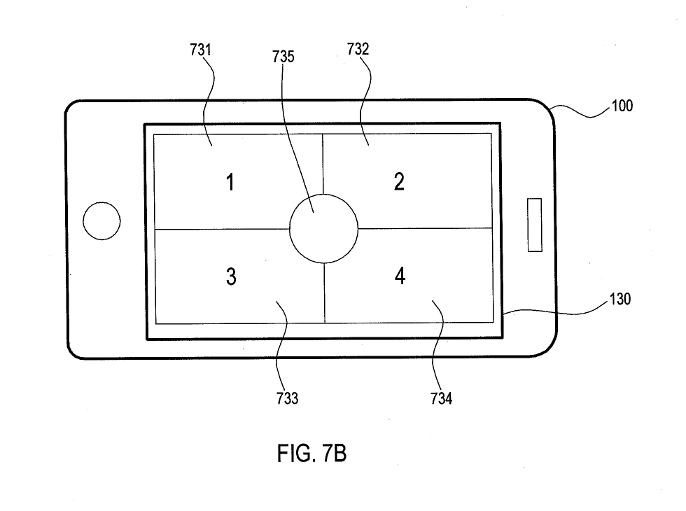

FIG. 7A is a perspective diagram of a fourth embodiment of a touch screen unlocking prompt for screen unlocking according to the present invention. FIG. 7B is a perspective diagram of a fifth embodiment of a touch screen unlocking prompt for screen unlocking according to the present invention. Referring to FIG. 7A and FIG. 7B, the touch display module 130 of the electronic device 100 is invisibly partitioned into a first input block 731, a second input block 732, a third input block 733, and a fourth input block 734 (as shown in FIG. 7A), and even an unlocking initiation block 735 (as shown in FIG. 7B) may be added. During unlocking, a pattern may be drawn on the touch display module 130 of the electronic device 100 according to the unlocking time. In such an unlocking manner, it is judged whether an initial position and a final position of the strokes of the pattern drawn within the unlocking time are located in a preset block. Therefore, in this embodiment, an allowable error range needs to be set for a result detected by the detection module, and information within the allowable error range can all be used as the unlocking instructions.

To sum up, the greatest difference between the present invention and a general unlocking manner lies in that, each unlocking instruction needs to correspond to unlocking time. Therefore, the unlocking information undoubtedly includes an unlocking instruction set including a unlocking instruction and an unlocking time series including a piece of unlocking time. In this way, for holders owning cell phones and PDAs, the user can set unlocking information with time information according to personal preference, thereby avoiding the cell phone and the PDA from being unlocked and used at will by another person, so as to improve privacy and convenience.

The technical content of the present invention has been disclosed through preferred embodiments, but is not intended to be limited thereto. Various variations and modifications made by persons skilled in the art without departing from the spirit of the present invention fall within the scope of the present invention as defined by the appended claims.

What is claimed is:

1. A screen unlocking method with time information, applicable to an electronic device, and comprising:
obtaining unlocking information through a detection module, wherein the unlocking information comprises an unlocking instruction set and an unlocking time series; and
performing judgment by using an operation processing module, and when the unlocking information conforms to preset unlocking information, unlocking a touch display module of the electronic device.

2. The screen unlocking method according to claim 1, wherein the preset unlocking information is set in the electronic device through a setting module, and the method comprises:
setting the preset unlocking information by using a presetting module; and
storing the preset unlocking information in the electronic device.

3. The screen unlocking method according to claim 1, wherein before the step of obtaining the unlocking information through the detection module, the screen unlocking method further comprises:
awaking the electronic device through a trigger key; and
displaying, by the touch display module, an unlocking prompt message.

4. The screen unlocking method according to claim 1, wherein in the step of obtaining the unlocking information through the detection module, the unlocking instruction set is formed by a combination of a unlocking instruction, each unlocking instruction corresponds to unlocking time, and several pieces of the unlocking time are combined into the unlocking time series.

5. The screen unlocking method according to claim 4, further comprising:
judging whether operating time of the unlocking instruction conforms to the corresponding unlocking time; and
if the operating time of the unlocking instruction does not conform to the unlocking time, continuously locking the touch display module.

6. The screen unlocking method according to claim 1, wherein in the step of obtaining the unlocking information through the detection module, the screen unlocking method further comprises:
enabling the electronic device to act in a specific manner such as a actuation manner of moving, swinging, shaking, and rotating; and
sensing an actuation direction and manner of the electronic device by using a direction sensing unit of the electronic device; and
using the sensed actuation direction and manner as the unlocking instruction.

7. The screen unlocking method according to claim 6, wherein when operating time of the moving direction and the rotation manner does not conform to corresponding unlocking time, the operation processing module enables the touch display module to be continuously locked.

8. The screen unlocking method according to claim 1, wherein in the step of obtaining the unlocking information through the detection module, the screen unlocking method further comprises:
sensing an unlocking voice signal by using an audio capture unit of the electronic device; and
using the sensed unlocking voice signal as the unlocking instruction.

9. The screen unlocking method according to claim 8, wherein when operating time of the unlocking voice signal does not conform to corresponding unlocking time, the operation processing module enables the touch display module to be continuously locked.

10. The screen unlocking method according to claim 1, wherein in the step of obtaining the unlocking information through the detection module, the screen unlocking method further comprises:
obtaining an unlocking image signal by using an image capture unit of the electronic device; and
using the sensed unlocking image signal as the unlocking instruction.

11. The screen unlocking method according to claim 10, wherein when operating time of the unlocking image signal does not conform to corresponding unlocking time, the operation processing module enables the touch display module to be continuously locked.

12. The screen unlocking method according to claim 1, wherein in the step of unlocking the touch display module of the electronic device, the screen unlocking method further comprises:
outputting, by the operation processing module, an unlocking signal to the touch display module; and
enabling the touch display module to be unlocked according to the unlocking signal, and to enter an operation picture with an application function.

13. A screen unlocking system with time information, applicable to an electronic device, and comprising:
a memory module;
a touch display module;
a setting module, used to set preset unlocking information, wherein the preset unlocking information comprises a preset unlocking instruction set and a preset unlocking time series; and store the preset unlocking information in the memory module;
a detection module, for obtaining unlocking information comprising an unlocking instruction set and an unlocking time series; and
an operation processing module, electrically connected to the memory module, the detection module, and the touch display module; and enabling the touch display module to be unlocked when obtaining through comparison that the unlocking information conforms to the preset unlocking information.

14. The screen unlocking system according to claim 13, wherein the electronic device is further disposed with a trigger key, so as to awake the electronic device through the trigger key, and the touch display module displays an unlocking prompt message.

15. The screen unlocking system according to claim 13, wherein the touch display module is further disposed with several input blocks, and several operating signals are obtained through the input blocks, so as to generate the unlocking instruction set.

16. The screen unlocking system according to claim 13, wherein the unlocking instruction set comprises a unlocking instruction, each unlocking instruction corresponds to unlocking time, and several pieces of the unlocking time are combined into the unlocking time series.

17. The screen unlocking system according to claim 13, further comprising a direction sensing unit, so as to sense a actuation manner of moving, swinging, shaking, and rotating of the electronic device.

18. The screen unlocking system according to claim 17, wherein the direction sensing unit is an electronic compass, so as to sense an actuation direction and manner of the electronic device, and use the sensed actuation direction and manner as an unlocking instruction.

19. The screen unlocking system according to claim 17, wherein the direction sensing unit is a gyroscope, so as to sense an actuation direction and manner of the electronic device, and use the sensed actuation direction and manner as an unlocking instruction.

20. The screen unlocking system according to claim 13, wherein the electronic device is further disposed with an audio capture unit, so as to obtain an unlocking voice signal and use the sensed unlocking voice signal as an unlocking instruction.

21. The screen unlocking system according to claim 13, wherein the electronic device is further disposed with an image capture unit, so as to obtain an unlocking image signal and use the sensed unlocking image signal as an unlocking instruction.

22. The screen unlocking system according to claim 13, wherein the operation processing module outputs an unlocking signal to the touch display module, so as to enable the touch display module to be unlocked according to the unlocking signal and to enter an operation picture with an application function.

23. A recording medium, for storing a program code readable to an electronic device, so as to execute a screen unlocking method with time information, wherein the screen unlocking method with time information comprises the following steps:
obtaining unlocking information through a detection module, wherein the unlocking information comprises an unlocking instruction set and an unlocking time series; and
judging, by using an operation processing module, whether the unlocking information conforms to preset unlocking information;
outputting, by the operation processing module, an unlocking signal to a touch display module; and
enabling the touch display module to be unlocked according to the unlocking signal, and to correspondingly enter an operation picture with an application function.
